(19) United States
(12) Patent Application Publication
(10) Pub. No.: US 2022/0241783 A1
(43) Pub. Date: Aug. 4, 2022

(54) REDUCED PATHLENGTH FLOW CELL FOR INLINE SAMPLE CHARACTERIZATION IN MODULAR FLUOROPOLYMER TUBING MICROFLUIDICS

(71) Applicant: North Carolina State University, Raleigh, NC (US)

(72) Inventors: Milad Abolhasani, Raleigh, NC (US); Robert EPPS, Raleigh, NC (US)

(21) Appl. No.: 17/722,002

(22) Filed: Apr. 15, 2022

Related U.S. Application Data
(63) Continuation of application No. PCT/US20/57045, filed on Oct. 23, 2020.
(60) Provisional application No. 62/926,644, filed on Oct. 28, 2019.

(51) Int. Cl. B01L 3/00

(52) U.S. Cl. CPC B01L 3/502715; B01L 2200/0652; B01L 2300/1805; B01L 2300/0663; B01L 2300/023

(57) ABSTRACT

A device for monitoring quality of nanomaterials fabricated in a microfluidic flow reactor includes a sensor coupled to a sample conduit of a microfluidic flow reactor, the sample conduit configured for providing a path for fluid flow comprising fabricated nanomaterial. The sensor includes a sensing region comprising a first plate and an opposing second plate, and a fastening mechanism for pulling the first and second plates towards each other to deform a portion of the sample conduit. A detector couples to the sensing region for capturing a spectroscopic signal from the sample conduit.

### CROSS-REFERENCE TO RELATED APPLICATION

This application claims the benefit of Patent Cooperation Treaty Application No. PCT/US20/57045 filed on Oct. 23, 2020, which claims priority to U.S. Provisional Patent Application No. 62/926,644, filed on Oct. 28, 2019, the entire contents of each of which is incorporated herein by reference.

### TECHNICAL FIELD

The present invention relates generally to the field of microfluidics, and particularly to a system and method for measuring yield of fabricated nanomaterials such as semiconductor nanocrystals including quantum dots (QDs).

### BACKGROUND

Interest in nanomaterials and nanocrystals has spiked in recent years. Quantum dots (QDs) are nanocrystals that emit light in the entire visible and near infrared spectral region depending on particle sizes and compositions. QDs possess chemical robustness, excellent optical and photovoltaic properties, in addition to composition tunability. This provides unique opportunities for optoelectronic applications and devices such as bioimaging, light emitting diodes (LEDs), visual displays, sensors, photovoltaic devices, lasers, and solid-state lighting, among others. QDs are very difficult to manufacture in a repeatable manner, particularly since any change in the size of the manufactured QDs will affect the color they emit. Current means of producing QDs through flask chemistry are poorly amenable to large-scale synthesis and require a highly specialized operator to make QDs of adequate quality in a repeatable manner.

As the global demand for nanomaterials quickly increases, better means of manufacturing QDs that is scalable and less specialized will be extremely valuable. Accordingly, opportunities exist for improving the quality of nanomaterials manufactured by various methods known in the art.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

In accordance with the purposes of the disclosed devices and methods, as embodied and broadly described herein, the disclosed subject matter relates to devices and methods of use thereof. Additional advantages of the disclosed devices and methods will be set forth in part in the description, which follows, and in part will be obvious from the description. The advantages of the disclosed devices and methods will be realized and attained by means of the elements and combinations particularly pointed out in the appended claims. It is to be understood that both the foregoing general description and the following detailed description are exemplary and explanatory only and are not restrictive of the disclosed compositions, as claimed.

The details of one or more embodiments of the invention are set forth in the accompanying drawings and the description below. Other features, objects, and advantages of the invention will be apparent from the description and drawings, and from the claims.

Disclosed herein is a device for monitoring quality of nanomaterials fabricated in a microfluidic flow reactor. According to at least one embodiment, the device includes a sensor coupled to a sample conduit of a microfluidic flow reactor. The sample conduit is configured for providing a path for fluid flow. The fluid flow includes fabricated nanomaterial. The sensor includes a sensing region comprising a first plate and an opposing second plate, and a fastening mechanism for pulling the first and second plates towards each other to deform a portion of the sample conduit to a predetermined level to provide a tunable pathlength of light therethrough. A detector couples to the sensing region for capturing a spectroscopic signal from the sample conduit.

According to one or more embodiments, the deformed portion of the sample conduit includes substantially parallel and flat walls of the sample conduit.

According to one or more embodiments, at least one plate includes a groove of a rectangular cross-section for receiving a portion of the sample conduit.

According to one or more embodiments, the detector couples to the sensing region at or near the deformed portion of the sample conduit.

According to one or more embodiments, the device further comprises an opening through one of the first and second plates for receiving the detector.

According to one or more embodiments, the fastening mechanism comprises at least two fasteners.

According to one or more embodiments, the fasteners comprise one or more of bolt and nuts, and a screw.

According to one or more embodiments, the plates comprise one or more of a metal and a plastic material.

According to one or more embodiments, the sample comprises a plurality of particles having an average particle size of 1 nm to 100 nm.

According to one or more embodiments, a force applied by the fastening mechanism to deform the portion of the sample conduit is computer controlled to adjust the pathlength of light.

According to one or more embodiments, one of the first and second plates includes two light paths and the other of the first and second plates includes a single light path.

According to one or more embodiments, the deforming of the portion of the sample conduit is one or more of tunable and reversible.

According to one or more embodiments, a length of the path traveled by the fluid flow is adjustable.

According to one or more embodiments, the deformed portion is substantially optically transparent (250 nm to 1100 nm).

According to one or more embodiments, the deformed portion of the sample conduit comprises a void, a window comprising a substantially optically transparent material, or a combination thereof.

According to one or more embodiments, the sample conduit comprises one or more modules. Each of the one or more modules comprises a fluid flow path of a predetermined length such that the sample conduit is configured to have a path for fluid flow of a desired length by fluidly connecting one or more modules.

According to one or more embodiments, the sample conduit comprises one or more of a Teflon tubing, and a substantially circular cross-section.

According to one or more embodiments, the deformed portion is substantially optically transparent (250 nm-1100 nm).

According to one or more embodiments, the deformed portion of the sample conduit comprises a void, a window comprising a substantially optically transparent material, or a combination thereof.

According to one or more embodiments, the detector comprises a spectrometer, wherein the spectrometer comprises: a Raman spectrometer, a UV-vis absorption spectrometer, an IR absorption spectrometer, a fluorescence spectrometer, or combinations thereof.

According to one or more embodiments, the device further comprises one or more of: a sample preparation element fluidly connected to a sample inlet of the sample conduit; and, a light source configured to illuminate the sample conduit at the deformed portion.

According to one or more embodiments, a total flow rate of the fluid flow is from 0.1 μL/min to 25,000 μL/min.

According to one or more embodiments, the microfluidic flow reactor further comprises the sample conduit providing a path for fluid flow extending from a sample inlet to a sample outlet. The sample conduit is formed from one or more modules. Each of the one or more modules comprises a fluid flow path of a predetermined length such that a sample conduit having a path for fluid flow of a desired length can be assembled by fluidly connecting one or more of the modules. The microfluidic flow reactor also includes a thermal housing enclosing the sample conduit. The thermal housing comprises a plurality of measurement regions. The microfluidic flow reactor additionally includes a motorized stage translatable along the thermal housing from a first location to a second location. The detector is coupled to the motorized stage such that the motorized stage is configured to translate the detector along the thermal housing align the detector with one or more of the deformed portions of the sample conduit.

Disclosed herein is a method of monitoring quality of nanomaterials fabricated in a microfluidic flow reactor using a device. According to various embodiments, the method includes providing a device comprising a sensor coupled to a sample conduit of a microfluidic flow reactor, the sample conduit configured for providing a path for fluid flow comprising fabricated nanomaterial, the sensor comprising a sensing region comprising a first plate and an opposing second plate; and a fastening mechanism for pulling the first and second plates towards each other to deform a portion of the sample conduit. The method further includes providing a detector coupled to the sensing region for capturing a spectroscopic signal from the sample conduit. The method furthermore includes capturing a spectroscopic signal from the sample conduit.

According to one or more embodiments, the signal is captured at or near the deformed portion of the sample conduit.

According to one or more embodiments, the method further comprises sending the captured spectrometric signal to a server in electronic communication with the device.

### BRIEF DESCRIPTION OF THE DRAWINGS

FIG. 1 is a semi-transparent perspective view of a portion of a modular type microfluidic flow reactor system, according to one or more embodiments of the presently disclosed subject matter.

FIG. 2 and FIG. 3 are perspective views of a microfluidic flow reactor system, according to one or more embodiments of the presently disclosed subject matter.

FIG. 4 is a semi-transparent perspective view of a portion of a modular type microfluidic flow reactor system, according to one or more embodiments of the presently disclosed subject matter.

FIG. 5 is a perspective view of a microfluidic flow reactor system, according to one or more embodiments of the presently disclosed subject matter.

FIG. 6 is a block diagram of a computing device forming part of a microfluidic flow reactor system, according to one or more embodiments of the presently disclosed subject matter.

FIG. 7 is a schematic structural diagram of a schematic synthesis of core/shell CdSe/ZnSe QD synthesis, according to one or more embodiments of the presently disclosed subject matter.

FIG. 8 is a schematic structural diagram of a system for fabricating perovskite quantum dots (QDs) using a microfluidic flow reactor system, according to one or more embodiments of the presently disclosed subject matter.

FIG. 9A is a side perspective view of a sensor connected to a sample conduit and forming part of a microfluidic flow reactor system; FIG. 9B is a side perspective view of the sensor disconnected from the sample conduit; FIG. 9C is a side plan view of the sensor with the sample conduit in an uncompressed disposition; and FIG. 9D is a side plan view of the sensor with the sample conduit in a compressed disposition, according to one or more embodiments of the presently disclosed subject matter.

FIG. 10A and FIG. 10B are graphical illustrations comparing photoluminescence with excitation wavelength absorption for a compressed tube flow cell and a cuvette at equivalent fluorescent dye concentrations; and FIG. 10C and FIG. 10D are graphical illustrations that provide a slope fitting for linear region of concentrations used to derive photoluminescence quantum yield for a compressed tube flow cell and a cuvette at equivalent fluorescent dye concentrations, according to one or more embodiments of the presently disclosed subject matter.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to “one embodiment” or “an embodiment” in the present disclosure can be, but not necessarily are, references to the same embodiment and such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

Embodiments of the presently disclosed subject matter advantageously provide for an improved system of measuring the quality of nanomaterials such as, for example, QDs manufactured by microfluidic flow reactors. In its broadest meaning, a microreactor is micro vessel designed to contain chemical reactions. Microreactors vary from simple capillary tubing to complex design integrating valves that include control of operation parameters and in-situ characterization. Capillary tubing microfluidic flow reactors incorporate many choices in terms of materials (e.g., polytetrafluoroethylene (PTFE), glass, and fused silica) with an inner diameter ranging from 25 μm to 1700 μm. The most commonly used microfluidic flow reactors are made of polymers that makes it easy to fabricate at low cost and with an acceptable feature resolution. An alternative to tubing microfluidic flow reactors is microfluidic chips fabricated using the popular soft lithography technique.

Microfluidic flow reactors exhibit intrinsic advantages of reduced chemical consumption, safety, high surface-area-to-volume ratios, and improved control over mass and heat transfer superior to the macroscopic reaction setting. An integrated microfluidic system represents a scalable integration of a microchannel. Integrated microfluidics-based chemical reactors for: (i) parallel screening of in situ click chemistry libraries, (ii) multistep synthesis of radiolabeled imaging probes for positron emission tomography (PET), (iii) sequential preparation of individually addressable conducting polymer nanowire (CPNW), and (iv) solid-phase synthesis of DNA oligonucleotides.

Microfluidic flow reactors can be used to fabricate nanomaterials such as, for example, perovskite quantum dots (PQDs). A microfluidic flow reactor such as, for example, a modular type flow reactor can be used to produce PQDs in batches. Batch synthesis of high-quality PQDs present well-known batch-to-batch variation that can affect the resulting products through variable and unfavorable heat and mass transfer kinetics. Quantum yield is a measure of quantum dot efficiency and can be derived from UV-Vis absorption and photoluminescence spectra. Quantum yield measurements are traditionally taken in a quartz cuvette, but in a flow reactor system they are taken directly from a small-diameter tube. However, the curvature of the tube distorts light traveling through the sample, which provides inaccurate measurements leading to inherent limitations in the quality analysis process.

Embodiments of the presently disclosed subject matter overcome various problems inherent in prior art systems and methods by providing for one or more systems, methods and devices directed to monitoring quality of nanomaterials fabricated in a microfluidic flow reactor in a scalable manner in a less complicated manner. In various embodiments, the systems, devices and methods disclosed herein include a sensor that provides for compressing a sample tube carrying the fabricated nanomaterial in one region in order to flatten the tube's curvature to thereby allow for a more accurate UV-Vis or photoluminescence measurement.

Embodiments of the presently disclosed subject matter accordingly provide for a device for monitoring quality of nanomaterials fabricated in a microfluidic flow reactor. Whereas the invention may be explained with regard to a microfluidic flow reactor, it should be noted that embodiments of the presently disclosed subject matter can be applied to any kind of microfluidic flow reactor/reactor system to provide for an improved way of measuring the quality of nanomaterials manufactured by such microfluidic flow reactor/reactor system.

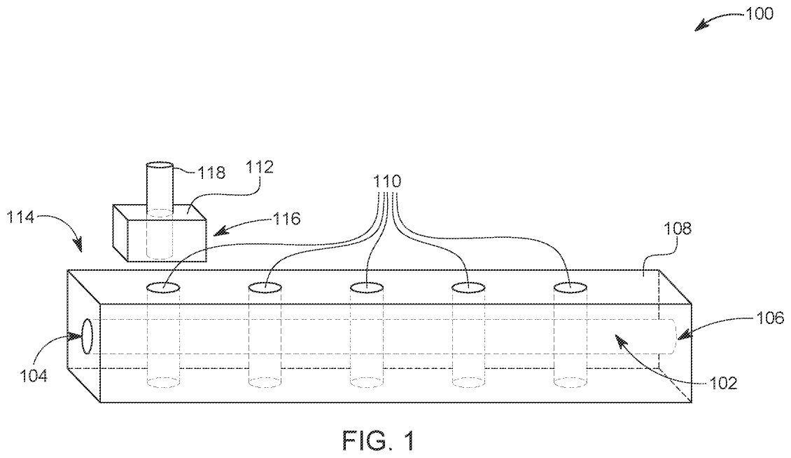

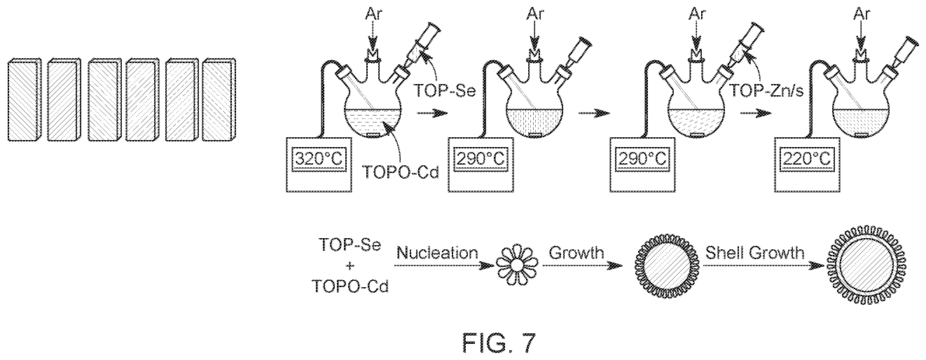

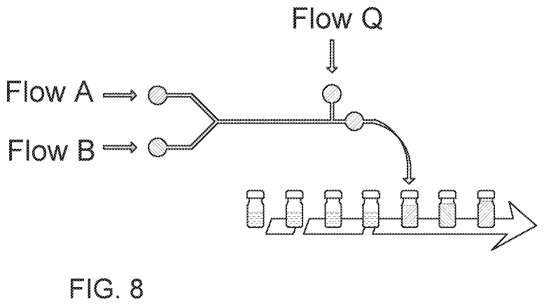

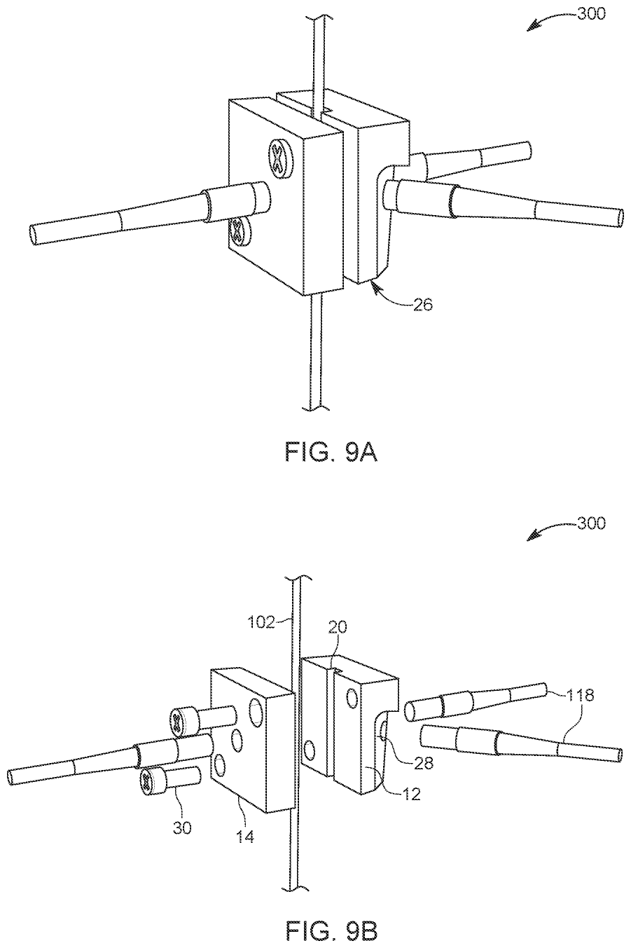

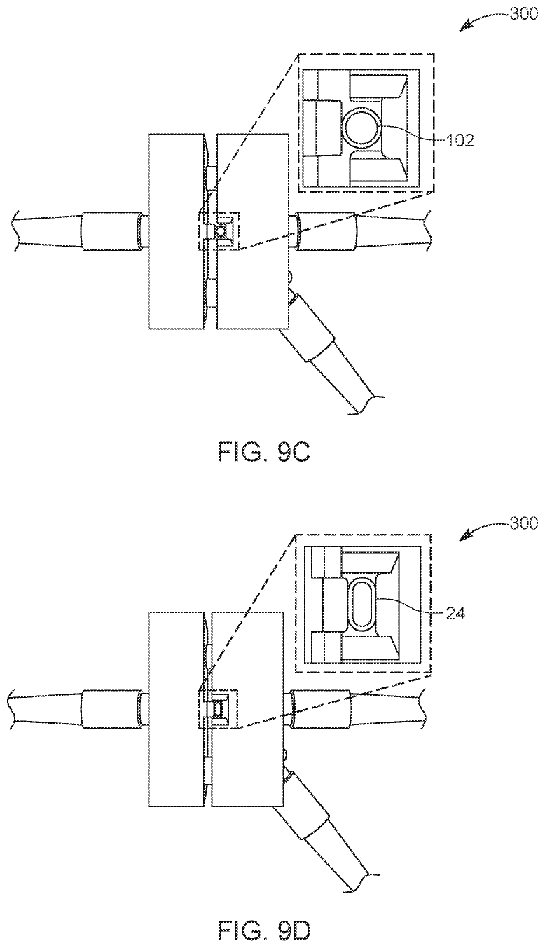

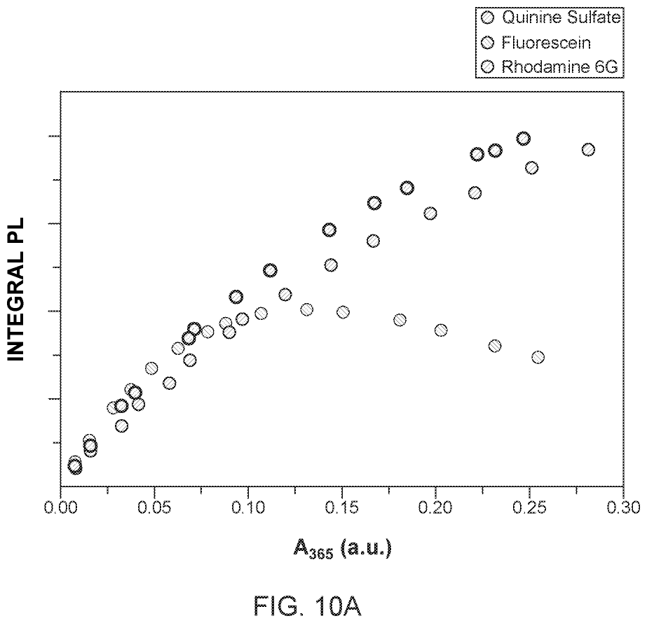

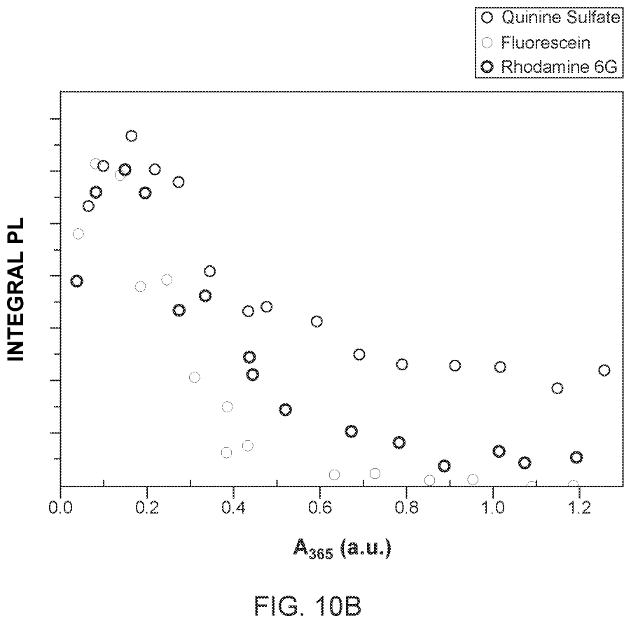

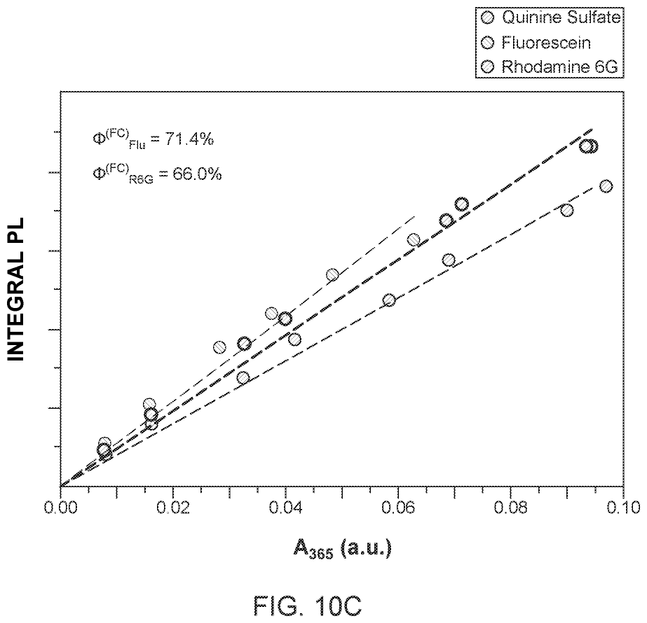

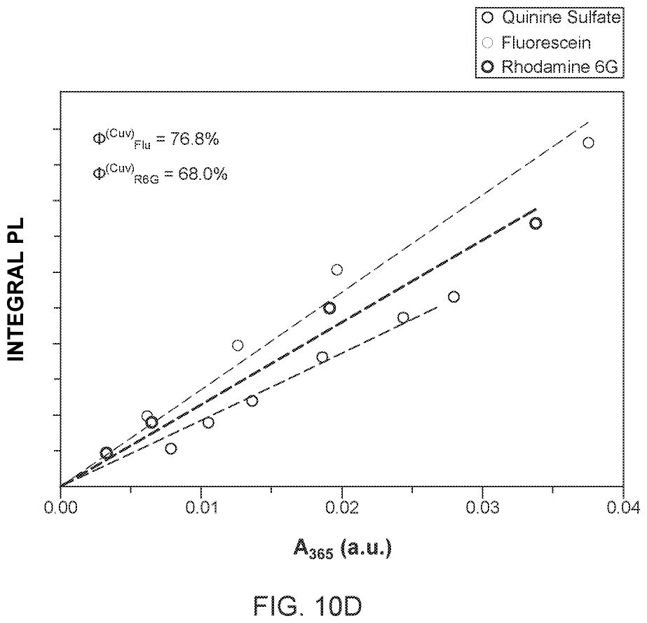

FIGS. 1 through 6 illustrate various aspects of a microfluidic flow reactor, FIGS. 7 and 8 illustrate various aspects of fabricating perovskite quantum dots, and FIGS. 9 and 10 illustrate various aspects of a sensor for monitoring quality of nanomaterials such as perovskite quantum dots (PQDs) fabricated in a microfluidic flow reactor using systems, devices and methods disclosed herein.

According to at least one embodiment, as illustrated in FIG. 9, sensor 300 is provided herein. Sensor 300 is configured for monitoring quality of nanomaterials such as perovskite quantum dots (PQDs) fabricated in a microfluidic flow reactor. Sensor 300 connects to a sample conduit and forms part of a microfluidic flow reactor system. FIG. 9A is a side perspective view of sensor 300 connected to a sample conduit and forming part of a microfluidic flow reactor system. FIG. 9B is a side perspective view of sensor 300 disconnected from the sample conduit. FIG. 9C is a side plan view of sensor 300 with the sample conduit in an uncompressed disposition. FIG. 9D is a side plan view of sensor 300 with the sample conduit in a compressed disposition, according to one or more embodiments of the presently disclosed subject matter.

In various embodiments, sensor 300 includes a sensing region 26 coupled to a sample conduit 102 that is in fluid communication with a microfluidic flow reactor (the microfluidic flow reactor is not shown in FIG. 9 but illustrated in FIGS. 1 through 6). According to various embodiments, sample conduit 102 is configured for providing a path for fluid flow comprising fabricated nanomaterial. The nanomaterial is fabricated at the microfluidic flow reactor. In various embodiments, sensing region 26 comprises first plate 12 and an opposing second plate 14. Sensor 300 further includes a fastening mechanism 30 for pulling first plate 12 and second plate 14 towards each other to deform or distort a portion of the sample conduit 102 to create deformed portion 24. Sensor 300 furthermore includes one or more detectors 118 coupled to the sensing region for capturing a spectroscopic signal from sample conduit 102.

In various embodiments, deformed portion 24 of sample conduit 102 includes substantially parallel outer surfaces, e.g., walls, of the sample conduit. Under existing systems, methods and devices, the curvature naturally present in the sample tube can distort light traveling through the sample resulting in inaccurate measurements leading inherent limitations in the quality analysis process. By contrast, the substantially parallel walls (and corresponding substantially parallel inner surfaces) of sample conduit 102 that is created in or near deformed portion 24 by the compression of sample conduit 102 carrying the fabricated nanomaterial flattens or substantially flattens the curvature of sample conduit 102. This flattening or substantial flattening of sample conduit 102 in or near deformed portion 24 allows for improved monitoring of the quality of nanomaterials such as perovskite quantum dots (PQDs) fabricated in a microfluidic flow reactor. The improved monitoring allows for better or improved yield of perovskite quantum dots (PQDs) fabricated by the microfluidic flow reactor.

In various embodiments, the flattening of the tube's curvature results from fastening mechanism 30 pulling first plate 12 and second plate 14 towards each other to precisely deform a portion of the sample conduit to a predetermined level to form or create deformed portion 24. This can advantageously allow for a more accurate UV-Vis or photoluminescence measurement at or near deformed portion 24 to thereby improve the monitoring of the quality of nanomaterials such as perovskite quantum dots (PQDs) fabricated in various microfluidic flow reactors. In various embodiments, the deformed portion 24 can be substantially spectroscopically transparent. In some embodiments, the deformed portion 24 of sample conduit 102 can include features such as a void, a window comprising a substantially spectroscopically transparent material, and combinations thereof. In various embodiments, a total flow rate of the fluid flow through the sample conduit can be from 0.1 μL/min to 25,000 μL/min. In various embodiments, the sample conduit is made up of a deformable material, such as, for example, a plastic material.

In various embodiments, the deformation is configured to be one or more of tunable and reversible. In at least one embodiment, the deformation is automated. In one embodiment, the force applied to create the deformation is computer-controlled such that a predetermined precise level of deformation is generated to provide a tunable pathlength for light therethrough. In one embodiment, a force applied by the fastening mechanism to deform the portion of the sample conduit is computer controlled to adjust the pathlength of light. IN one embodiment, one of the first and second plates includes two light paths (e.g., two fibers) and the other of the first and second plates includes a single light path (e.g., a single fiber).

In one embodiment, the deforming of the portion of the sample conduit is tunable, for example, by the provision of a computer-controlled system that adjusts the pressure applied by the fastening mechanism. The computer-controlled system may further include a feedback loop by way of sensing device that measures the pathlength for light as the pathlength varies in response to the change in the level of deformity of the sample conduit. In one embodiment, the deforming of the portion of the sample conduit is reversible, for example, by the provision of a computer-controlled system that adjusts the pressure applied by the fastening mechanism is gradually reduced such to partially or completely reverse the deformity caused by the fastening mechanism on the portion of the sample conduit. Accordingly, in various embodiments, the force applied to the tubing and amount of deformation can be automatically controlled to precisely control the final pathlength. In one embodiment, the computer-controlled system includes processing unit 202, in addition to various software and hardware components.

In at least one embodiment, at least one of first plate 12 and second plate 14 includes a groove such as groove 20 configured for receiving a portion of the sample conduit 102 as illustrated, for example, in FIG. 9. In some embodiments, only one plate includes the groove. In some embodiments, both of first plate 12 and second plate 14 can include the groove. In some embodiments, the groove can have a rectangular cross-section profile or a square cross-section profile to facilitate the formation of parallel flat walls of sample conduit 102 at or near deformed portion 24.

Sensor 300 can further include one or more openings 28 provided through one or more of first plate 12 and second plate 14 for receiving detectors 118. In various embodiments, detectors 118 can couple to the sensing region 26 at or near deformed portion 24 of the sample conduit 102. In various embodiments, detectors 118 can be inserted into, or otherwise made to fit into, openings 28.

In some embodiments, fastening mechanism 30 comprises two or more fasteners. For example, in one embodiment, four fasteners can be provided. The fastening mechanism can include any type currently available in the market including nuts and bolts, screws, pins and rivets, seams, crimps, snap-fits, shrink-fits, and other fastening mechanisms that can pull the first and second plates towards each other to deform a portion of the sample conduit precisely and provide a tunable pathlength for the light. For example, in one embodiment, the fasteners comprise screws. In another example, the fasteners comprise bolt and nuts.

First plate 12 and second plate 14 can be fabricated of any suitable material based on the requirements of the particle being fabricated, the application at hand, and the operating environment at hand. For example, plates 12, 14 can be made of metal in one embodiment. In another embodiment, plates 12, 14 can be made of plastics such as acrylic or polymethyl methacrylate (PMMA), polycarbonate (PC), polyethylene (PE), polypropylene (PP), polyethylene Terephthalate (PETE or PET), polyvinyl Chloride (PVC), acrylonitrile-Butadiene-Styrene (ABS), and similar other plastic materials. In various embodiments, other types of materials can also be used depending on the application and the operating environment at hand.

In at least one embodiment, detector 118 can form part of a spectrometer. The spectrometer can be a Raman spectrometer, a UV-vis absorption spectrometer, an IR absorption spectrometer, a fluorescence spectrometer, or combinations thereof.

In various embodiments, the method of monitoring quality of nanomaterials fabricated in a microfluidic flow reactor using a device includes providing a microfluidic flow reactor and a device coupled to the microfluidic flow reactor. The device coupled to the microfluidic flow reactor comprises a sensor coupled to a sample conduit of a microfluidic flow reactor. The sample conduit is configured for providing a path for fluid flow comprising fabricated nanomaterial. The sensor comprises a sensing region. The sensing region comprises a first plate, an opposing second plate, and a fastening mechanism for pulling the first and second plates towards each other to deform a portion of the sample conduit precisely and provide a tunable pathlength for the light. The device further includes a detector coupled to the sensing region for capturing a spectroscopic signal from the sample conduit. The method of monitoring can include capturing a spectroscopic signal from the sample conduit. The signal is captured at or near the deformed portion of the sample conduit. The method can further include sending the captured spectrometric signal to a server in electronic communication with the device. The captured spectrometric signal may be transferred to the server through a wired connection or a wireless connection.

Accordingly, as illustrated in FIGS. 9A to 9D for example, embodiments of the presently disclosed subject matter provides for or includes a simple device such as sensor 300 that compresses the sample tube in one region as to flatten the sample tube's curvature for a more accurate UV-Vis or photoluminescence measurement. In various embodiments, sensor 300 can incorporate or allow for an adjustable path length for the fluid flow of the fabricated nanomaterials (of a sample) in front of a light transmitted through the sample conduit. Stated differently, the span of the path traveled in front of a light transmitted through the sample conduit by the fluid flow of the fabricated nanomaterials (of a sample) can be adjusted. This feature can advantageously permit for accurate characterization of the quality of the synthesized nanomaterials without diluting the sample. Accordingly, in various embodiments, a length of the path traveled by the fluid flow in front of a light transmitted through the sample conduit is adjustable. Sensor 300 accordingly incorporates or allows for the flattening of the curved surface of a tubular sample conduit to thereby reduce the light scattering through the wall of the sample conduit while providing a uniform path length for the fabricated nanomaterials in the sample comprising the fluid flow exposed to the light transmitted through the conduit. This feature can advantageously allow for improving the accuracy of the characterization of the quality of the synthesized nanomaterials.

The sensor as mentioned herein couples to a sample conduit of microfluidic flow reactor. The microfluidic flow reactor includes the sample conduit providing a path for fluid flow extending from a sample inlet to a sample outlet. In one embodiment, the sample conduit can be formed from one or more modules. In one embodiment, each of the one or more modules can comprise a fluid flow path of a predetermined length such that the sample conduit of a desired length can be assembled by fluidly connecting one or more of the modules. In one embodiment, the microfluidic flow reactor can also include a thermal housing enclosing the sample conduit. The thermal housing can include a plurality of measurement regions. In one embodiment, the microfluidic flow reactor can also include a motorized stage translatable along the thermal housing from a first location to a second location. The detector as described herein can be coupled to the motorized stage such that the motorized stage is configured to translate the detector along the thermal housing align the detector with one or more of the deformed portions of the sample conduit. In one embodiment, the microfluidic flow reactor can further include a sample preparation element fluidly connected to a sample inlet of the sample conduit; and a light source configured to illuminate the sample conduit at the deformed portion.

FIG. 7 is a schematic structural diagram of a schematic synthesis of core/shell CdSe/ZnSe QD synthesis, according to one or more embodiments of the presently disclosed subject matter. FIG. 8 is a schematic structural diagram of a system for fabricating perovskite quantum dots (QDs) using a microfluidic flow reactor system, according to one or more embodiments of the presently disclosed subject matter. FIG. 10A and FIG. 10B are graphical illustrations comparing photoluminescence with excitation wavelength absorption for a compressed tube flow cell and a cuvette at equivalent fluorescent dye concentrations. FIG. 10C and FIG. 10D are graphical illustrations that provide a slope fitting for linear region of concentrations used to derive photoluminescence quantum yield for a compressed tube flow cell and a cuvette at equivalent fluorescent dye concentrations.

In one embodiment, as illustrated in FIG. 1, the sensor as described herein is coupled to a modular microfluidic flow reactor device such as device 100. As shown in FIG. 1, device 100 comprises a sample conduit 102 providing a path for fluid flow extending from a sample inlet 104 to a sample outlet 106. Device 100 can further include a thermal housing 108 that encloses sample conduit 102. The thermal housing 108 can include a plurality of measurement regions 110. Device 100 further includes a detector 118 configured to capture a spectroscopic signal from the sample conduit 102 at one or more measurement regions 110. Device 100 can also include a motorized stage 112 translatable along the thermal housing 108 from a first location 114 to a second location 116, wherein the detector 118 is coupled to the motorized stage 112 such that the motorized stage 112 is configured to translate the detector 118 along the thermal housing 108 align the detector 118 with one or more of the plurality of measurement regions 110. As used herein, “aligning” a detector with one or more of the plurality of measurement regions means that the detector can spectroscopically interrogate a fluid sample present within the sample conduit. In various embodiments, measurement regions 110 can be the same as or similar to sensing region 26 as illustrated in FIG. 9. In some embodiments, measurement regions 110 can be located at or near sensing region 26 as illustrated, for example, in FIG. 9.

Sample conduit 102 can have any suitable shape. In some examples, sample conduit 102 can have a substantially circular cross-section. Sample conduit 102 can comprise any suitable material. In some examples, the sample conduit 102 can comprise a material sold by the tradename Teflon. In certain examples, sample conduit 102 can have an inner diameter of 0.01 inches or more. The inner diameter of the sample conduit 102 can range from any of the minimum values described above to any of the maximum values described above. For example, the sample conduit 102 can have an inner diameter of from 0.01 inches to 0.1 inches. In certain examples, sample conduit 102 can have an outer diameter of 0.0625 inches or more. In some examples, sample conduit 102 can have an outer diameter of 0.125 inches or less. The outer diameter of sample conduit 102 can also range from 0.0625 inches to 0.125 inches. The length of sample conduit 102 from sample inlet 104 to sample outlet 106 can be selected, in some examples, based on the desired characteristic of the sample. For example, the length of sample conduit 102 from sample inlet 104 to sample outlet 106 can be 1 centimeter (cm) or more. In some examples, the length of sample conduit 102 from sample inlet 104 to sample outlet 106 can be 500 cm or less. The length of sample conduit 102 from sample inlet 104 to sample outlet 106 can range from 1 cm to 500 cm.

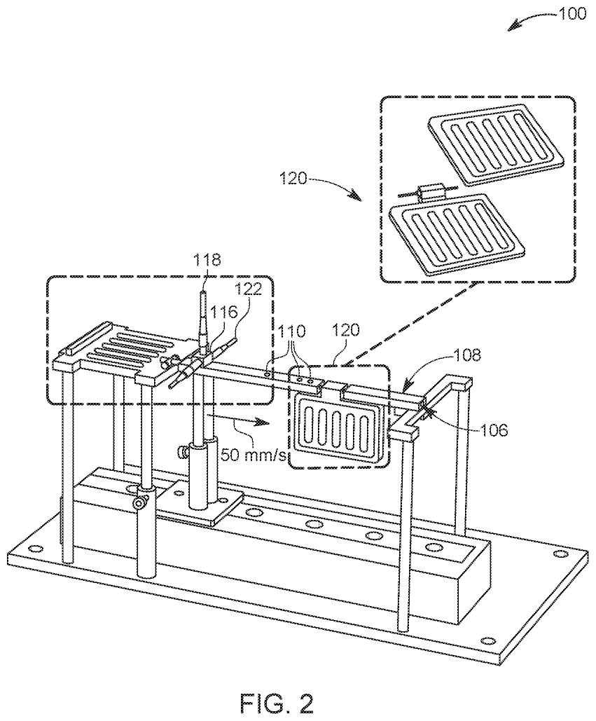

Referring to FIG. 2, in some examples, device 100 can comprise one or more modules 120. Each module 120 includes a fluid flow path of a predetermined length such that sample conduit 102 can be configured to have a path for fluid flow of a desired length by fluidly connecting one or more modules 120. Thermal housing 108 can comprise any suitable thermally conductive material. In some examples, thermal housing 108 can comprise a metal (e.g., aluminum). The plurality of measurement regions 110 can, for example, be substantially spectroscopically transparent. As used herein, “substantially spectroscopically transparent” is meant to include any material that is substantially transparent at the wavelength or wavelength region of interest. The plurality of measurement regions 110 can, for example, comprise a plurality of voids, a plurality of windows comprising a substantially spectroscopically transparent material, and combinations thereof. The substantially spectroscopically transparent material can comprise glass, quartz, silicon dioxide, a polymer, and combinations thereof. According to at least one embodiment, the deformed portion is substantially optically transparent (e.g., over a wavelength range of 250 nm-1100 nm).

Devices 100 can further comprise a light source 122. Light source 122 can be any type of light source including natural light sources (e.g., sunlight) and artificial light sources (e.g., incandescent light bulbs, light emitting diodes, gas discharge lamps, arc lamps, lasers etc.). In some examples, light source 122 can comprise an incandescent light bulb, a light emitting diode, a gas discharge lamp, an arc lamp, a laser, or a combination thereof. In certain examples, the light source comprises a light emitting diode, a halogen lamp, a tungsten lamp, or a combination thereof. Light source 122 is configured to illuminate sample conduit 102 at one or more of the measurement regions 110. In some examples, light source 122 can be coupled to motorized stage 112 such that motorized stage 112 is configured to translate light source 122 along thermal housing 108. The detector 118 can comprise, for example, a camera, an optical microscope, an electron microscope, a spectrometer, or combinations thereof. In some examples, detector 118 comprises a spectrometer. Examples of spectrometers include, but are not limited to, Raman spectrometers, UV-vis absorption spectrometers, IR absorption spectrometers, fluorescence spectrometers, and combinations thereof. In certain examples, the device can further comprise a three-port cell coupled the motorized stage. The three-port cell can hold one or more detectors and one or more light sources. In certain examples, the light source can comprise an LED light source and the detector can comprise a fluorescence spectrometer, wherein device 100 is configured such that the LED light source and the fluorescence spectrometer are aligned perpendicular to one another with respect to the measurement region. In certain examples, the light source can comprise a broadband light source and the detector can comprise an absorption spectrometer, wherein the device is configured such that the broadband light source is in-line with the absorption spectrometer with respect to the measurement region.

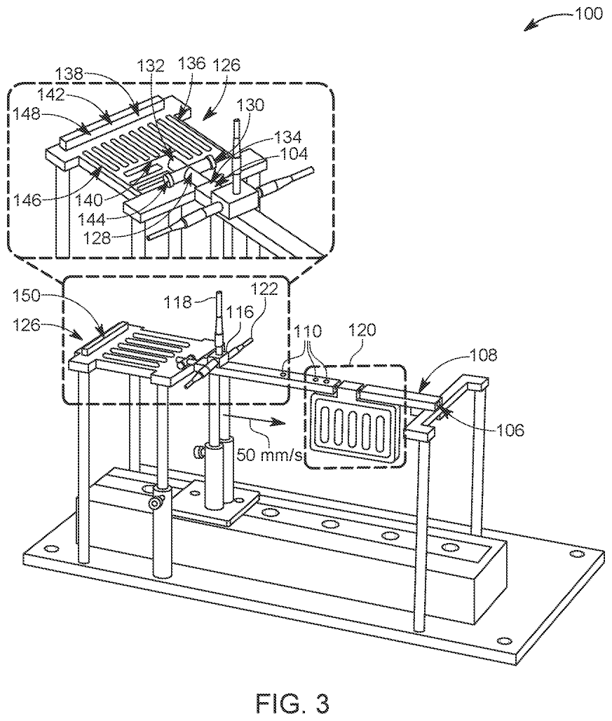

Referring to FIG. 3, device 100 can further include a sample preparation element 126 fluidly connected to sample inlet 104. Sample preparation element 126 can include a chamber 128 for sample mixing Chamber 128 can include a first inlet 130, a second inlet 132, and an outlet 134. First inlet 130, second inlet 132, and outlet 134 are fluidly connected via the chamber 128. Outlet 134 is also fluidly connected to the sample inlet 104. Chamber 128 can further include a first precursor conduit 136 fluidly connecting a first precursor inlet 138 to the first inlet 130 of chamber 128, and a second precursor conduit 140 fluidly connecting a second precursor inlet 142 to the second inlet 132 of chamber 128. In some examples, chamber 128 can further include a third inlet 144. Sample preparation element 126 can further include a continuous phase conduit 146 fluidly connecting a continuous phase inlet 148 to third inlet 144 of chamber 128. In some examples, chamber 128 further comprises a mixing element. The inclusion or exclusion of sample preparation element 126 as well as the number of inlets in chamber 128 can be selected such that device 100 can be configured for single-phase or multi-phase flow (e.g., gas-liquid or liquid-liquid).

Sample preparation element 126 can further comprise a thermal jacket 150, wherein the thermal jacket 150 substantially encapsulates chamber 128, first precursor conduit 136, second precursor conduit 140, and, when present, continuous phase conduit 146. Thermal jacket 150 can comprise any suitable thermally conductive material. In some examples, the thermal jacket 150 comprises a metal (e.g., aluminum). The device 100 can, in some examples, further comprise a heating element thermally connected to one or more of thermal jacket 150 and thermal housing 108 to control the temperature of the thermal jacket 150 and/or the thermal housing 108. The heating element can set or maintain the temperature of the thermal jacket 150 and/or the thermal housing 108 to a temperature of, for example, 25° C. or more. In some examples, the heating element can set or maintain the temperature of thermal jacket 150 and/or thermal housing 108 to a temperature of 210° C. or less. The temperature that the heating element sets thermal jacket 150 and/or thermal housing 108 to can range from 25° C. to 210° C. For example, the heating element can set the temperature of thermal jacket 150 and/or thermal housing 108 to a temperature of from 25° C. to 210° C.

In some examples, device 100 can further include an injector fluidly connected to a sample reservoir such that the injector is configured to inject a sample into sample conduit 102 at a first flow rate via sample inlet 104. In some examples, device 100 can further comprise an injector fluidly connected to a first precursor reservoir such that the injector is configured to inject an amount of a first precursor from the first precursor reservoir into first precursor conduit 136 via first precursor inlet 138. Device 100 can further include an injector fluidly connected to a second precursor reservoir such that the injector is configured to inject an amount of a second precursor from the second precursor reservoir into the second precursor conduit 140 via the second precursor inlet 142, thereby forming a sample in chamber 128. In some examples, device 100 can also include an injector fluidly connected to chamber 128 such that the injector is configured to inject the sample from chamber 128 into sample conduit 102 at a first flow rate via sample inlet 104. In some examples, device 100 can further include injector fluidly connected to a continuous phase reservoir such that the injector is configured to inject an amount of a continuous phase into continuous phase conduit 146 via continuous phase inlet 148. In some examples, the one or more injectors can be configured such that device 100 can be configured for single-phase or multi-phase flow (e.g., gas-liquid or liquid-liquid). The first flow rate can, for example, be 0.1 microliters per minute (μL/min) or more. In some examples, the first flow rate can be 25,000 μL/min or less. The first flow rate can range from any of the minimum values described above to any of the maximum values described above. For example, the first flow rate can be from 0.1 μL/min to 25,000 μL/min.

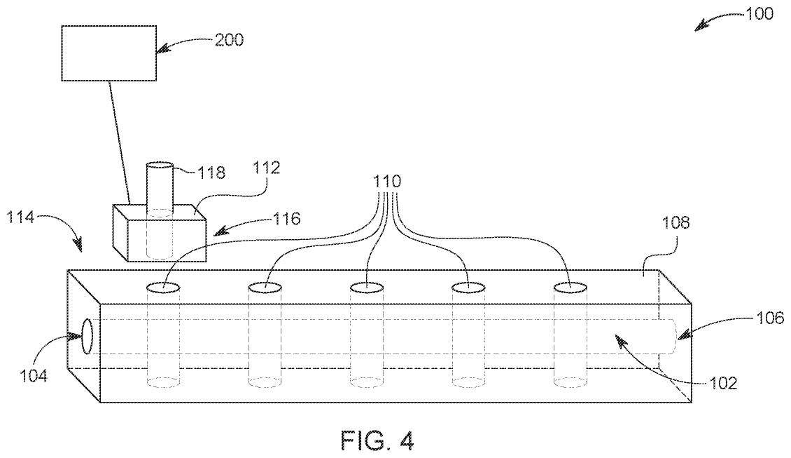

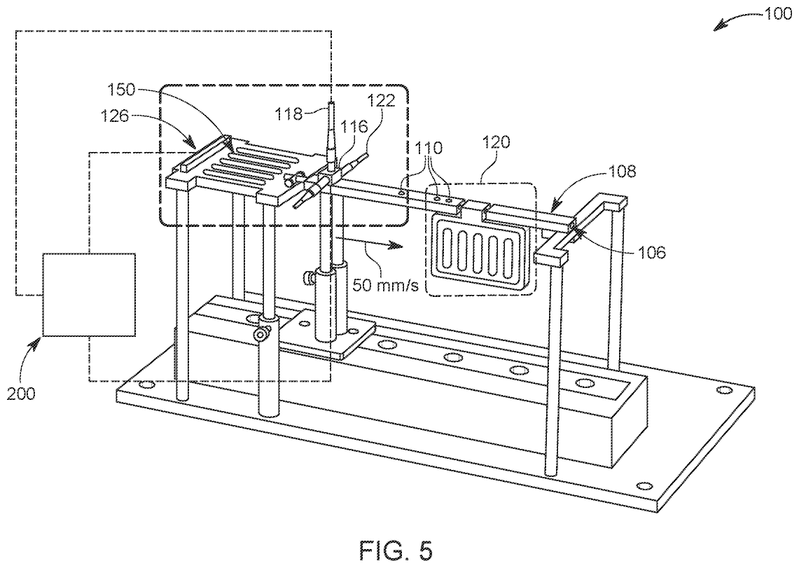

In some examples, device 100 further comprises a second detector fluidly coupled to the sample outlet 106. In some examples, device 100 can further comprise a chromatograph fluidly coupled to the sample outlet 106. In some examples, device 100 can further comprise a computing device 200 configured to send, receive, and/or process signals from the motorized stage, the detector, the light source, the heating element, an injector fluidly coupled to a sample reservoir such that the injector is configured to inject a sample into the sample conduit 102 at a first flow rate via the sample inlet 104, an injector fluidly connected to a first precursor reservoir such that the injector is configured to inject an amount of a first precursor into the first precursor conduit 136 via the first precursor inlet 138, an injector fluidly connected to a second precursor reservoir such that the injector is configured to inject an amount of a second precursor into the second precursor conduit 140 via second precursor inlet 142, an injector fluidly connected to a continuous phase reservoir such that the injector is configured to inject an amount of a continuous phase into continuous phase conduit 146 via continuous phase inlet 148, or a combination thereof, for example as shown in FIG. 4 and FIG. 5. FIG. 5 is a perspective view of a microfluidic flow reactor system including device 100.

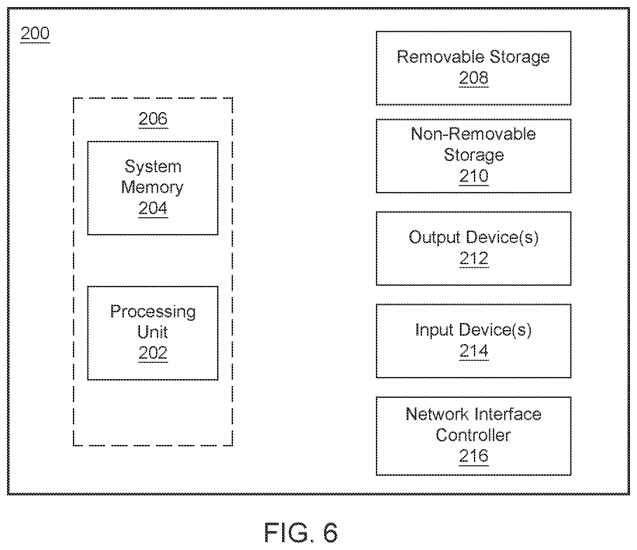

FIG. 6 illustrates an example computing device 200 upon which examples disclosed herein may be implemented. Computing device 200 can include a bus or other communication mechanism for communicating information among various components of the computing device 200. In its most basic configuration, computing device 200 typically includes at least one processing unit 202 (a processor) and system memory 204. Depending on the exact configuration and type of computing device, system memory 204 may be volatile (such as random access memory (RAM)), non-volatile (such as read-only memory (ROM), flash memory, etc.), or some combination of the two. This most basic configuration is illustrated in FIG. 6 by a dashed line 206. Processing unit 202 may be a standard programmable processor that performs arithmetic and logic operations necessary for operation of the computing device 200.

Computing device 200 can have additional features/functionality. For example, computing device 200 may include additional storage such as removable storage 208 and non-removable storage 210 including, but not limited to, magnetic or optical disks or tapes. Computing device 200 can also contain network connection(s) 216 that allow the device to communicate with other devices. Computing device 200 can also have input device(s) 214 such as a keyboard, mouse, touch screen, antenna or other systems configured to communicate with the camera in the system described above, etc. Output device(s) 212 such as a display, speakers, printer, etc. may also be included. The additional devices can be connected to the bus in order to facilitate communication of data among the components of computing device 200.

Processing unit 202 can be configured to execute program code encoded in tangible, computer-readable media. Computer-readable media refers to any media that is capable of providing data that causes computing device 200 (i.e., a machine) to operate in a particular fashion. Various computer-readable media can be utilized to provide instructions to processing unit 202 for execution. Common forms of computer-readable media include, for example, magnetic media, optical media, physical media, memory chips or cartridges, a carrier wave, or any other medium from which a computer can read. Example computer-readable media can include, but is not limited to, volatile media, non-volatile media and transmission media. Volatile and non-volatile media can be implemented in any method or technology for storage of information such as computer readable instructions, data structures, program modules or other data and common forms are discussed in detail below. Transmission media can include coaxial cables, copper wires and/or fiber optic cables, as well as acoustic or light waves, such as those generated during radio-wave and infra-red data communication. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, processing unit 202 can execute program code stored in system memory 204. For example, the bus can carry data to system memory 204, from which processing unit 202 receives and executes instructions. The data received by system memory 204 can optionally be stored on the removable storage 208 or non-removable storage 210 before or after execution by processing unit 202. Computing device 200 typically includes a variety of computer-readable media. Computer-readable media can be any available media that can be accessed by computing device 200 and includes both volatile and non-volatile media, removable and non-removable media. Computer storage media include volatile and non-volatile, and removable and non-removable media implemented in any method or technology for storage of information such as computer readable instructions, data structures, program modules or other data. System memory 204, removable storage 208, and non-removable storage 210 are all examples of computer storage media.

Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 200. Any such computer storage media can be part of computing device 200.

It should be understood that the various techniques described herein can be implemented in connection with hardware or software or, where appropriate, with a combination thereof. Thus, the methods, systems, and associated signal processing of the presently disclosed subject matter, or certain aspects or portions thereof, can take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs can implement or utilize the processes described in connection with the presently disclosed subject matter, e.g., through the use of an application programming interface (API), reusable controls, or the like. Such programs can be implemented in a high level procedural or object-oriented programming language to communicate with a computer system. However, the program(s) can be implemented in assembly or machine language, if desired. In any case, the language can be a compiled or interpreted language and it may be combined with hardware implementations.

In some examples, the signals from the motorized stage, the detector, the light source, the heating element, an injector fluidly coupled to a sample reservoir such that the injector is configured to inject a sample into the sample conduit 102 at a first flow rate via the sample inlet 104, an injector fluidly connected to a first precursor reservoir such that the injector is configured to inject an amount of a first precursor into the first precursor conduit 136 via the first precursor inlet 138, an injector fluidly connected to a second precursor reservoir such that the injector is configured to inject an amount of a second precursor into the second precursor conduit 140 via the second precursor inlet 142, an injector fluidly connected to a continuous phase reservoir such that the injector is configured to inject an amount of a continuous phase into the continuous phase conduit 146 via the continuous phase inlet 148, or a combination thereof, can be sent, received, and/or processed in whole or in part on one or more computing device. In one example, device 100 can comprise one or more additional computing devices.

In certain examples, system memory 204 has computer-executable instructions stored thereon that, when executed by the processor, cause the processor to:
a. translate the motorized stage 112 along the thermal housing 108 to such that the detector 118 is aligned at a first location proximate a first measurement region;
b. capture a first spectroscopic signal via the detector 118 at the first location proximate the first measurement region, wherein the first spectroscopic signal has a first intensity;
c. optionally, store the first spectroscopic signal and/or the intensity of the first spectroscopic signal;
d. optionally, output the first spectroscopic signal and/or the intensity of the first spectroscopic signal;
e. translate the motorized stage 112 along the thermal housing 108 from the first location proximate the first measurement region to a second location proximate the first measurement region;
f. capture a second spectroscopic signal via the detector 118 at the second location proximate the first measurement region, wherein the second spectroscopic signal has a second intensity;
g. optionally, store the first spectroscopic signal and/or the intensity of the first spectroscopic signal;
h. optionally, output the first spectroscopic signal and/or the intensity of the first spectroscopic signal;
i. compare the intensity of the first spectroscopic signal to the intensity of the second spectroscopic signal;
j. repeat steps a-i to find the location at which the intensity of the spectroscopic signal is largest, thereby determining the location of the first measurement region; and
k. output the location of the first measurement region.

In some examples, system memory 204 can include computer-executable instructions stored thereon that, when executed by the processor, cause the processor to repeat steps a-k to determine and output the location of a second measurement region.

In some examples, the sample can comprise a plurality of particles, such as a plurality of metal particles, a plurality of semiconductor particles, a plurality of nanoparticles or nanomaterials, or a combination thereof. In some examples, the sample can comprise a plurality of polymer capped metal particles, such as a plurality of plasmonic particles, a plurality of quantum dots, a plurality of just-fabricated nanoparticles/nanomaterials or combinations thereof. The plurality of particles can have an average particle size. “Average particle size” and “mean particle size” are used interchangeably herein, and generally refer to the statistical mean particle size of the particles in a population of particles. For example, the average particle size for a plurality of particles with a substantially spherical shape can comprise the average diameter of the plurality of particles. For a particle with a substantially spherical shape, the diameter of a particle can refer, for example, to the hydrodynamic diameter. As used herein, the hydrodynamic diameter of a particle can refer to the largest linear distance between two points on the surface of the particle. For an anisotropic particle, the average particle size can refer to, for example, the average maximum dimension of the particle (e.g., the length of a rod shaped particle, the diagonal of a cube shape particle, the bisector of a triangular shaped particle, etc.) For an anisotropic particle, the average particle size can refer to, for example, the hydrodynamic size of the particle. Mean particle size can be measured using methods known in the art, such as evaluation by scanning electron microscopy, transmission electron microscopy, and/or dynamic light scattering.

In one example, the plurality of particles can have an average particle size of 1 nanometer (nm) or more. In some examples, the plurality of particles can have an average particle size of 1 micrometer (micron, μm) or less. The average particle size of the plurality of particles can range from any of the minimum values described above to any of the maximum values described above. For example, the plurality of particles can have an average particle size of 1 nm to 1 micron. In some examples, the plurality of particles can be substantially monodisperse. “Monodisperse” and “homogeneous size distribution,” as used herein, and generally describe a population of particles where all of the particles are the same or nearly the same size. As used herein, a monodisperse distribution refers to particle distributions in which 80% of the distribution (e.g., 85% of the distribution, 90% of the distribution, or 95% of the distribution) lies within 25% of the median particle size (e.g., within 20% of the median particle size, within median particle size). The plurality of particles can comprise particles of any shape (e.g., a sphere, a rod, a quadrilateral, an ellipse, a triangle, a polygon, etc.). In some examples, the plurality of particles can have an isotropic shape. In some examples, the plurality of particles can have an anisotropic shape.

In some examples, the plurality of particles can comprise a first population of particles comprising a first material and having a first particle shape and a first average particle size and a second population of particles comprising a second material and having a second particle shape and a second average particle size; wherein the first particle shape and the second particle shape are different, the first material and the second material are different, the first average particle size and the second average particle size are different, or a combination thereof. In some examples, the plurality of particles can comprise a mixture of a plurality of populations of particles, wherein each population of particles within the mixture is different with respect to shape, composition, size, or combinations thereof. In some examples, the sample can comprise an organic molecule.

It should be noted that, whereas sensor 300 has been described with regard to a microfluidic flow reactor, sensor 300 can be applied to any microfluidic flow reactor as a person of skill in the relevant art would understand.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example, reference to “a device” can include a plurality of such devices, and so forth.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A device for monitoring quality of nanomaterials fabricated in a microfluidic flow reactor, the device comprising:
a sensor coupled to a sample conduit of a microfluidic flow reactor, the sample conduit configured for providing a path for fluid flow,
the fluid flow comprising fabricated nanomaterial,
the sensor comprising:
a sensing region comprising a first plate and an opposing second plate; and
a fastening mechanism for pulling the first and second plates towards each other to deform a portion of the sample conduit to a predetermined level to provide a tunable pathlength of light therethrough,
wherein a detector couples to the sensing region for capturing a spectroscopic signal from the sample conduit.

2. The device of claim 1, wherein the deformed portion of the sample conduit includes substantially parallel and flat walls of the sample conduit.

3. The device of claim 1, wherein at least one plate includes a groove of a rectangular cross-section for receiving a portion of the sample conduit.

4. The device of claim 1, wherein the detector couples to the sensing region at or near the deformed portion of the sample conduit.

5. The device of claim 1, further comprising an opening through one of the first and second plates for receiving the detector.

6. The device of claim 1, wherein a force applied by the fastening mechanism to deform the portion of the sample conduit is computer controlled such as to adjust the pathlength of light.

7. The device of claim 6, wherein one of the first and second plates includes two light paths and the other of the first and second plates includes a single light path.

8. The device of claim 1, wherein the deforming of the portion of the sample conduit is one or more of tunable and reversible.

9. The device of claim 1, wherein the sample comprises a plurality of particles having an average particle size of 1 nm to 100 nm.

10. The device of claim 1, wherein a length of the path traveled by the fluid flow is adjustable.

11. The device of claim 1, wherein the sample conduit comprises one or more of a deformable material, and a substantially circular cross-section.

12. The device of claim 1, wherein the deformed portion is substantially optically transparent (250 nm to 1100 nm).

13. The device of claim 1, wherein the deformed portion of the sample conduit comprises a void, a window comprising a substantially optically transparent material, or a combination thereof.

14. The device of claim 1, wherein the detector comprises a spectrometer, wherein the spectrometer comprises: a Raman spectrometer, a UV-vis absorption spectrometer, an IR absorption spectrometer, a fluorescence spectrometer, or combinations thereof.

15. The device of claim 1, further comprising one or more of: a sample preparation element fluidly connected to a sample inlet of the sample conduit; and, a light source configured to illuminate the sample conduit at the deformed portion.

16. The device of claim 1, wherein a total flow rate of the fluid flow is from 0.1 μL/min to 25,000 μL/min.

17. The device of claim 1, where in the microfluidic flow reactor further comprises:
the sample conduit providing the path for fluid flow extending from a sample inlet to a sample outlet, wherein the sample conduit is formed from one or more modules, wherein each of the one or more modules comprises a fluid flow path of a predetermined length such that the sample conduit providing the path for fluid flow of a desired length can be assembled by fluidly connecting one or more of the modules; and
a thermal housing enclosing the sample conduit, wherein the thermal housing comprises a plurality of measurement regions; and
a motorized stage translatable along the thermal housing from a first location to a second location, wherein the detector is coupled to the motorized stage such that the motorized stage is configured to translate the detector along the thermal housing aligning the detector with one or more of the deformed portions of the sample conduit.

18. A method of monitoring quality of nanomaterials fabricated in a microfluidic flow reactor using a device, the method comprising:
providing a device comprising a sensor coupled to a sample conduit of a microfluidic flow reactor, the sample conduit configured for providing a path for fluid flow comprising fabricated nanomaterial, the sensor comprising a sensing region comprising a first plate and an opposing second plate; and a fastening mechanism for pulling the first and second plates towards each other to deform a portion of the sample conduit,
providing a detector coupled to the sensing region for capturing a spectroscopic signal from the sample conduit; and
capturing a spectroscopic signal from the sample conduit.

19. The method of claim 18, wherein the signal is captured at or near the deformed portion of the sample conduit.

20. The method of claim 19, wherein the method further comprises: sending the captured signal to a server in electronic communication with the device.
